(19) United States
(12) Patent Application Publication
(10) Pub. No.: US 2007/0138829 A1
(43) Pub. Date: Jun. 21, 2007

(54) Auto armour

(76) Inventors: Thomas J. Leyendecker, Lake Worth, FL (US); Timothy P. Leyendecker, Palm Beach, FL (US)

Correspondence Address: JAMES RAY & ASSOCIATES, 2640 PITCAIRN ROAD, MONROEVILLE, PA, 15146, US

(21) Appl. No.: 11/400,500

(22) Filed: Apr. 7, 2006

Related U.S. Application Data
(60) Provisional application No. 60/751,890, filed on Dec. 20, 2005.

(51) Int. Cl. B60J 11/00

(52) U.S. Cl. 296/136.02

(57) ABSTRACT

A device for providing protection for an exterior surface of a motorized vehicle. The device comprises a cover for draping over such motorized vehicle and a plurality of inflatable air chambers which are disposed intermediate such cover and such motorized vehicle for providing a cushion for any moving debris. There is a means that is in fluid communication with the plurality of air chambers for inflating the air chambers.

### CROSS REFERENCE TO RELATED APPLICATIONS

This application is closely related to and claims benefit from U.S. Provisional Application Ser. No. 60/751,890 filed Dec. 20, 2005.

### FIELD OF THE INVENTION

The present invention relates, in general, to a car cover, and, more particularly, the present invention relates to a car cover that has a built in blow-up air chamber for protecting the surface of a vehicle.

### BACKGROUND OF THE INVENTION

For many car owners parking the automobile outdoors is a convenience and for many it may be the only option. There are many problems that are of concern for the owner who must park outdoors. One major problem is the security of the vehicle. However, another almost equally important problem relates to maintaining the beauty of the exterior surface of the car.

A car left outdoors is susceptible to all sorts of damage from the elements. Rain, sun, snow and ice can all have an effect on the exterior of the vehicle. Standard car covers or tarps can keep the rain or sun from damaging or discoloring the paint surface of the automobile. However, high winds and blowing or falling debris can cause damage to a car's exterior even when using a standard cover. This is particularly true for automobiles that are parked outdoors in areas, such as Florida, the Gulf coast states or even some of the midwestern states, where high winds, tornadoes or hurricanes are prevalent. Even houses in many of these areas that are constructed with built in garages will generally need protection for their vehicles since garages in many of these areas are typically used for storage since a large number of the homes are not built with basements. That leaves no place for cars, so the cars, by necessity, are left outside. Thus, it would be advantageous if there were a cover that would protect a vehicle even in some of the more severe conditions.

### SUMMARY OF THE INVENTION

In a first aspect the present invention provides a device for providing protection for an exterior surface of a motorized vehicle. The device comprises a cover for draping over such motorized vehicle and a plurality of air chambers which are inflatable disposed intermediate such cover and such motorized vehicle for providing a cushion for any moving debris. There is a means that is in fluid communication with the plurality of air chambers for inflating the air chambers.

### OBJECTS OF THE INVENTION

It is, therefore, one of the primary objects of the present invention to provide a cover for a vehicle that is parked outdoors.

Another object of the present invention is to provide a cover for a vehicle that would provide an air cushion for the exterior of the vehicle to protect it from falling or flying debris.

Still another object of the present invention is to provide a cover for a vehicle that would have an inflatable chamber built in that would protect the vehicle from more than just falling rain.

Yet another object of the present invention is to provide a cover for a vehicle that would have an inflatable chamber that is easy to inflate.

Another object of the present invention is to provide a cover for a vehicle that is easy to remove and store.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a cutaway diagram of the air chambers of the device according to an embodiment of the invention.

FIG. 2 is a cutaway drawing of the cover portion of the device for covering a motorized vehicle.

FIG. 3 is a motorized vehicle covered with such device according to an embodiment of the invention.

FIG. 4 is a motorized vehicle covered with such device showing a means for inflating such air chamber.

FIG. 5 is a side view of such motorized vehicle with the cover on it showing the cover and air chamber connected and showing the air chambers above portions of such motorized vehicle.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

As illustrated in the drawing Figures the present invention provides a device, generally designated 10, for providing protection for an exterior surface of a motorized vehicle. The device 10 comprises a cover 2 for draping over such motorized vehicle and a plurality of inflatable air chambers 4 which are disposed intermediate such cover 2 and such motorized vehicle for providing a cushion for any moving debris, be it falling or flying. There is a means, generally designated 20, that is in fluid communication with the air chambers 4 for inflating the air chambers 4.

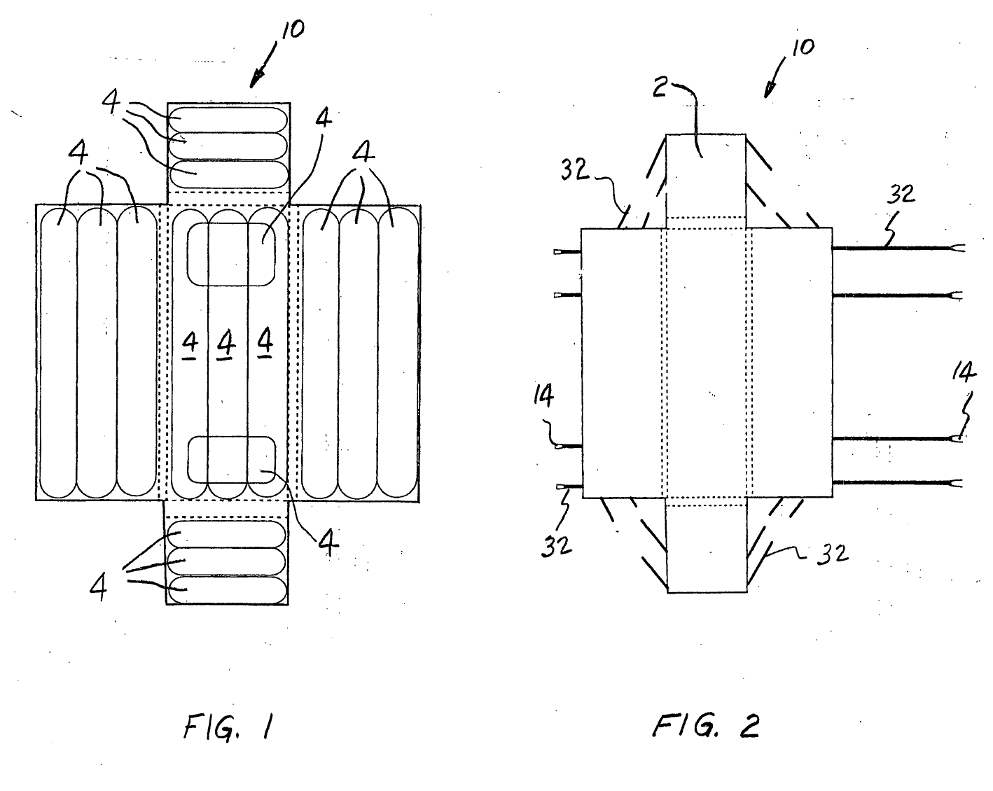

As is evident in FIG. 2, the device 10 further includes a means, generally designated 30, for securing such cover 2 to such motorized vehicle. Such means 30 includes at least one of rope 32, cable 32, straps 32, and stretchable cord 32. Stretchable cord 32 is what is commonly called “Bungee Cord”. Straps 32 are the presently preferred means 30 for securing such cover 2 to such motorized vehicle. Such means 30 further includes clips 14 that are disposed on the end of such straps 32. Such cover 2 goes over the air chambers 4 and then the clips 14 are used to secure the cover in the front, back and the undercarriage of the vehicle.

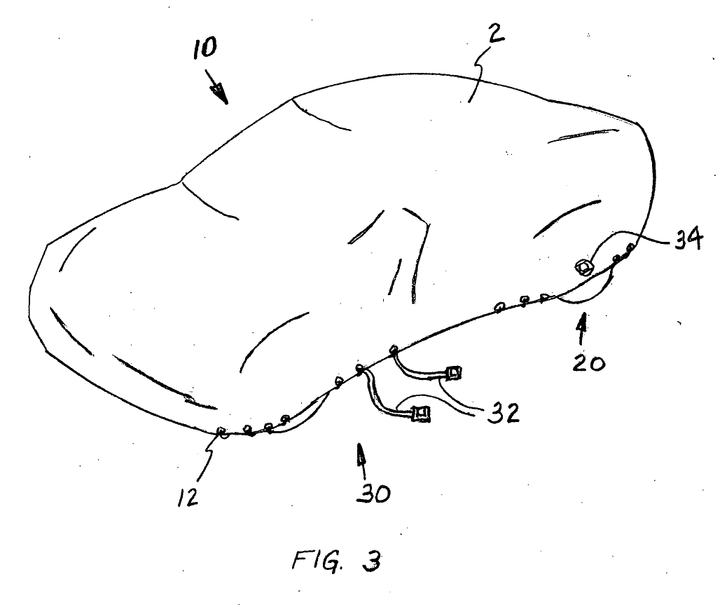

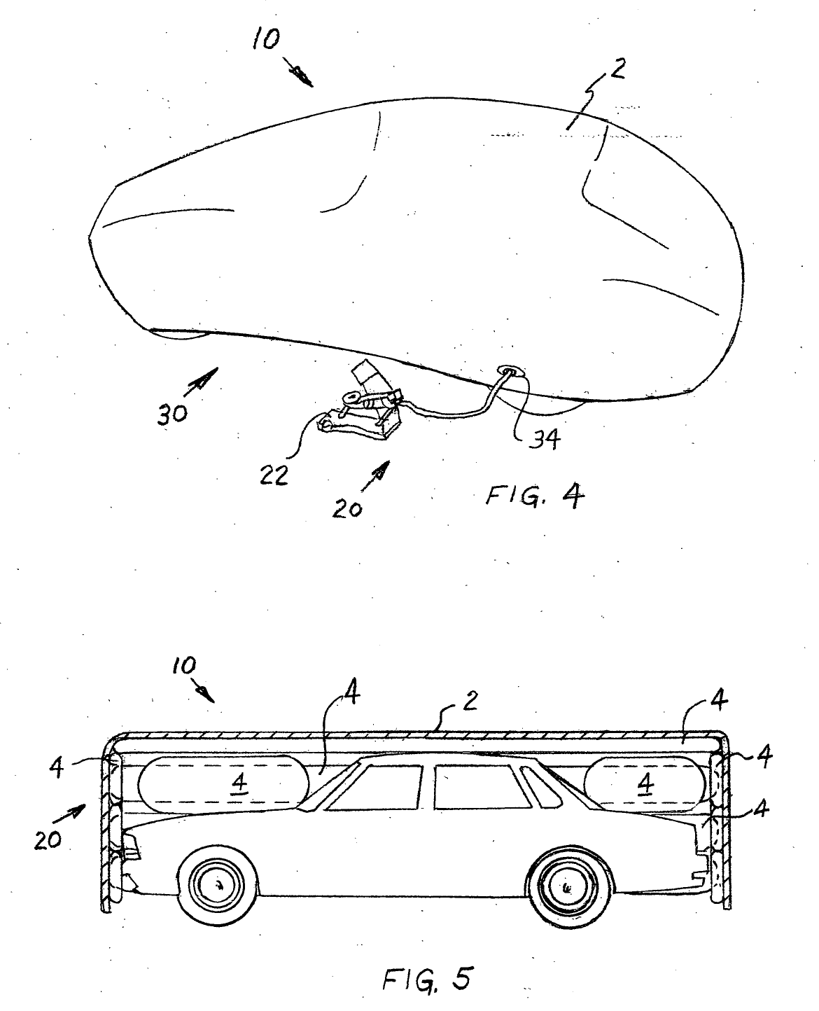

In an alternate embodiment, as seen in FIG. 3, such means 30 includes eyelets 12 disposed along a bottom area of the cover 2 for securing the cover 2 to such vehicle. Such means 30 also includes stretchable cord 32 which is connected to such eyelets 12.

The means 20 for inflating the air chambers 4 includes an air pump 22. Such air pump is one of battery operated and electrically operated. It is presently preferred that such air pump 22 is battery operated for convenience since this would keep everything together without the need of an electrical outlet. The small air pump 22 is used to pump air through an air valve 34 to the air chambers 4. The air valve 34 is also used to deflate the air chambers 4. Such cover 2 is contoured so as to easily and snugly fit around a vehicle. Such contoured cover 2 includes allowance areas for external rear view mirrors.

Such cover 2 and such air chambers 4 may be connected to each other such that when the cover 2 is one of mounted on the vehicle or removed from such motorized vehicle the air chambers 4 are mounted or removed simultaneously. Such air chambers 4 and such cover 2 may be connected to each other by means of sewing, snaps, hook and loop fasteners or double faced tape. It is presently preferred that such connection is by means of sewing.

The air chamber 4 is referred to many times as an air chamber 4; however, it is basically a plurality of air chambers 4. This is clearly evident in FIG. 1, wherein there are air chambers 4 which protects the roof of the vehicle, windshield and rear window areas. There are air chambers 4 which also protect the front of the car, hood and trunk areas as well as air chambers 4 which protect the sides or doors of the vehicle.

The device is an automobile cover with a built in inflatable air chambers 4. The device is similar in design and appearance to a standard car cover. However, the unique air chambers 4 that line the underside of the cover creates a cushioning to prevent damaging debris from contacting the car. Inflation and deflation of the cover is simple; a small air pump is used to pump air through an air valve and the air valve is used to deflate the air cushions. The cover is secured with the use of eyelets positioned around the bottom of the cover. Users can slip the cover over the car, securing it as desired and inflate the air chambers to the appropriate level. Removing the cover is as simple as deflating the air cushion, removing securing devices and slipping the cover off of the car. The device can be stored conveniently until needed again.

The present invention is substantially an air bag for the vehicle protecting the vehicle from flying debris caused by storms. When debris from falling branches or other flying objects come into contact with the vehicle, they are deflected by the cover and the built in air chambers, thus saving the car owner and the insurance companies from costly repairs as has been evident in recent years.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. A device for providing protection for an exterior surface of a motorized vehicle, said device comprising:
(a) a cover for draping over such motorized vehicle;
(b) a plurality of inflatable air chambers disposed intermediate said cover and such motorized vehicle for providing a cushion for any moving debris; and
(c) a means in fluid communication with said plurality of inflatable air chambers for inflating said plurality of air chambers.

2. The device, according to claim 1, wherein said device further includes a means for securing said cover to such motorized vehicle.

3. The device, according to claim 2, wherein said means includes at least one of rope, cable, stretchable cord and straps.

4. The device, according to claim 3, wherein said means is straps.

5. The device, according to claim 4, wherein said means further includes clips disposed on an outer end of said straps.

6. The device, according to claim 1, wherein said means for inflating said plurality of air chambers includes an air pump.

7. The device, according to claim 6, wherein said air pump is one of battery operated and electrically operated.

8. The device, according to claim 1, wherein said cover is contoured to easily and snugly fit around a vehicle.

9. The device, according to claim 8, wherein said contoured cover further includes allowance areas for external rear view mirrors.

10. The device, according to claim 1, wherein said said plurality of air chambers are interconnected to each other and with said means for inflating said air chambers.

11. The device, according to claim 10, wherein said cover and said plurality of air chambers are engageable with each other by one of sewing, snaps, hook and loop fasteners and double faced tape.

12. The device, according to claim 11, wherein said cover and said plurality of air chambers are engageable with each other by sewing.

13. The device, according to claim 11, wherein said cover and said plurality of air chambers are removably engageable with each other.

14. The device, according to claim 1, wherein said means for inflating said plurality of air chambers further includes a valve that is in fluid communication with said plurality of air cushions.

15. The device, according to claim 2, wherein said means for securing said cover includes eyelets disposed along a bottom area of said cover for securing said cover to such vehicle.

16. The device, according to claim 15, wherein said means for securing said cover is a stretchable cord.
